(19) United States
(12) Patent Application Publication
(10) Pub. No.: US 2005/0021328 A1
(43) Pub. Date: Jan. 27, 2005

(54) Audio coding

(76) Inventors: Leon Maria Van De Kerkhof, Eindhoven (NL); Arnoldus Werner Johannes Oomen, Eindhoven (NL)

Correspondence Address: Corporate Patent Counsel;Philips Electronics North America Corporation, PO Box 3001, Briarcliff Manor, NY, 10510, US

(21) Appl. No.: 10/495,948

(22) PCT Filed: Nov. 22, 2002
(86) PCT No.: PCT/IB02/04869

(30) Foreign Application Priority Data
Nov. 23, 2001 (EP) 01204533.2

(51) Int. Cl. G10L 19/00

(52) U.S. Cl. 704/216

(57) ABSTRACT

A method using sources in a multi-channel audio coding system for encoding a set of audio signals wherein correlated components are present. The method comprises the step of determining, from the relation between said audio signals, a composition of said sources, the composition being such that the sources in said composition are substantially uncorrelated, so that said composition of sources synthesizes said components in a relation-preserved way. The method may further comprise the step of encoding the sources, by determining for each source a set of parameters for synthesizing said source and a set of transformation parameters for generating said composition of sources.

The invention relates to audio coding, and in particular to coding a set of audio signals wherein correlated components are present.

International application WO99/04505 describes a method of encoding only perceptually relevant quantities of noise sources, such as, for instance, the total acoustic energy of noise in a specific frequency range, by which perceptually irrelevant audio information may be discarded so that a considerable signal compression may be gained. In this method, noise-like components of an input signal are detected on a frequency-band basis. The noise-like components are parameterized, and only the total power of the substituted spectral coefficients is transmitted. In a decoder, the encoded audio channels are reconstructed by inserting random noise sources with the desired power for the substituted spectral coefficients.

Such a straightforward substitution causes an unnatural hearing sensation in the case where multiple audio channels actually exhibit a degree of cross-correlation. This unnatural perception is due to the fact that the human ear is able to identify a correlation between audio signals coming from different directions. The correlation between signals determines the “stereo image”, the spatial perception of sound sources. If the left and right signals in a two-channel loudspeaker setup are fully correlated, the human auditory system will perceive this as a single sound source positioned in between the speakers. If the signals are uncorrelated, two separate sound sources positioned at the left and right speakers will be perceived. Partly correlated signals will generally be perceived as a wide sound source in between the speakers. Negative correlation can even lead to perceived sound source positions outside the speakerbase. Therefore, if correlation of the sound in left and right speakers is lost, the intended stereo effect disappears and a listener perceives a less natural hearing sensation.

In other words, if a sound produced from multiple audio channels reflects a single audio source that was recorded via said channels, a reconstruction of said audio source with uncorrelated noise sources would appear to be unnatural.

In the aforementioned application, it is attempted to compensate for the above-described effect by encoding a bit value, which, in an active state, triggers a synthesizer to use the same noise source for both left and right channel. In a normally inactive state, left and right channels are synthesized from independent noise sources.

Although such a provision offers an improvement as compared to a synthesis of audio channels using inherently uncorrelated noise sources, synthesized sounds still lack naturalness because, in practice, information in the encoded audio channels, describing a degree of correlation between the channels is not used. Therefore, a reconstruction of the original sound is only partly possible when using the known method and the ear still perceives a less natural hearing sensation.

The invention aims to provide an improved audio coding, wherein a perceptually near original reconstruction of components in multiple audio channels is possible, with a preserved degree of correlation between the channels. To this end, the invention provides a method for coding, a method for decoding, an encoder, a decoder, a data carrier and a signal as defined in the independent claims. Advantageous embodiments are defined in the dependent claims.

According to a first aspect of the invention, for the coding of a set of audio signals having correlated components, a composition of sources is determined from the relation between said audio signals, the composition being such that the sources in said composition are mutually uncorrelated or substantially uncorrelated, so that said composition of sources synthesizes said components in a relation-preserved way. A composition represents the sources and how these sources should be composed in order to synthesize the components. Such synthesizing may be performed in an encoder as well as in a decoder.

According to an embodiment of the invention, components present in an audio signal are composed from sources that synthesize perceptually relevant correlation-preserved noise components present in at least one frequency band of said audio signals. These synthesizing sources are mutually uncorrelated. Therefore, these sources can be easily reconstructed by independent generators.

In a preferred embodiment, the invention further comprises the steps of encoding the sources, by determining for the sources a set of parameters for synthesizing said sources and a set of transformation parameters for generating said composition of sources.

Furthermore, a preferred embodiment of the invention comprises the step of transmitting said sets of parameters for synthesizing each source and transmitting said set of transformation parameters for forming said plurality of sources. More specifically, said synthesizing parameters and said transformation parameters are determined by orthogonalizing/de-correlating the correlation matrix of said set of audio channels. This de-correlation may be, for a time-varying crosscorrelation between audio channels, performed on a frame-by-frame basis. The size of a frame may depend on the time frame through which the cross-channel correlations can be considered to be constant. De-correlation is common general knowledge in the art, see e.g. J. Edward Jackson, A User's Guide to Principal Components John Wiley & Sons, Inc. 1991 pp. 1-25.

The invention is preferably applicable in a case wherein the set of audio signals is divided into a selected set of frequency bands, at least one of the frequency bands comprising noise-like signals. Non-noisy components present in said audio signals may be encoded by sinusoidal coding.

Encoded and transmitted audio signals may be decoded and a corresponding multi-channel correlation preserved audio signal may be synthesized.

The encoder and decoder may be physically distinct signal processing apparatuses or may be present as one or several units in a single signal processing apparatus. The transmission may be a wireless transmission, or a transmission through the Internet, in fact, any kind of transmission. The transmission may also be done via a physical data carrier, such as a magnetic disk or a CD-rom etc.

Further objects and features of the invention will become apparent from the drawings, wherein:

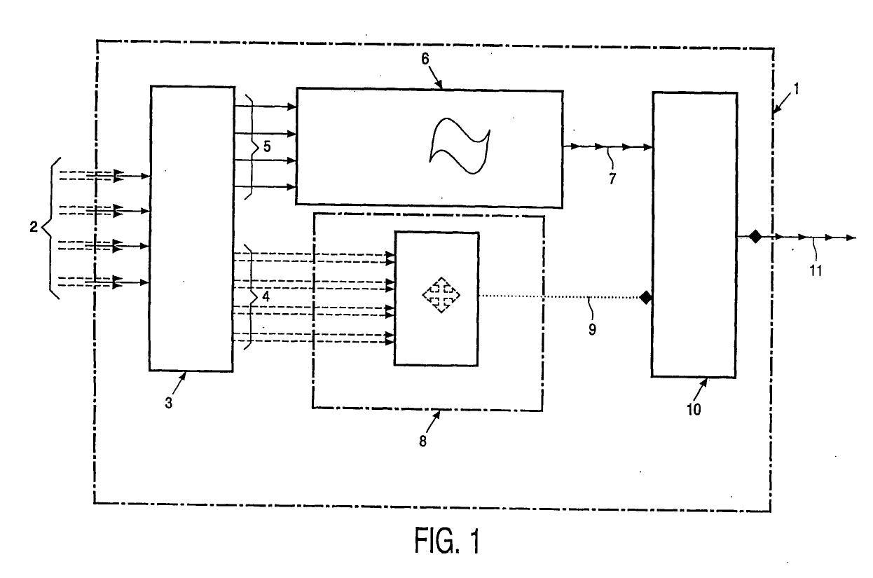

FIG. 1 is a schematic illustration of an encoding apparatus implementing the coding method according to the invention.

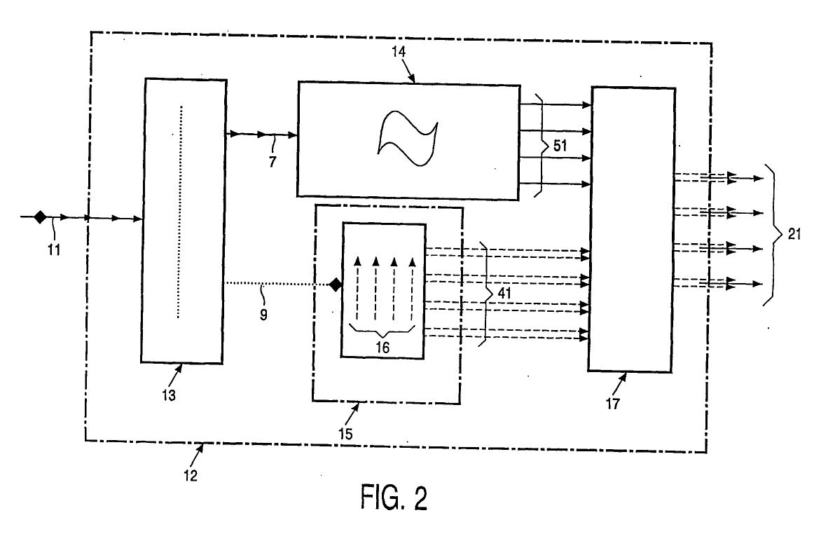

FIG. 2 is a schematic illustration of a decoding apparatus implementing the coding method according to the invention.

FIG. 1 shows an encoder 1 for encoding a four-channel audio signal. The audio channels are represented by four composite arrows 2, each composite arrow 2 representing one audio channel out of four channels. For the invention, the actual number of channels is irrelevant, because obviously, the inventive method can be applied in any audio system as long as more than 1 channel is present. The audio channel 2 comprises an audio signal which in at least one frequency band comprises noise components. In actual embodiments, an audio signal with audible frequency components is usually split up into several (usually logarithmically scaled) frequency bands, although the method according to the invention can also be performed directly on full bandwidth audio signals. For each, or a specific number, of these frequency bands (especially in relevant frequency bands where the human ear is sensitive to correlated signals), the inventive method can be applied.

The multi-channel signal 2 is filtered in a filter stage 3. The filter 3 splits up the audio signals into noisy parts 4 and in non-noisy parts 5. Non-noisy parts 5 of the signal 2 are directed towards a sinusoidal coding circuit 6. This circuit 6 generates compressed encoded data 7, which represents non-noisy audio information of said audio signals 2.

The noisy parts 4 are directed towards a circuit 8 encoding the noise in a correlation-preserved way according to the invention. In said circuit 8, the relation between said audio signals is determined and a composition of noise sources is identified, the composition being such that the noise sources in said composition are mutually uncorrelated, so that said composition of noise sources synthesizes said noise components in a relation-preserved way.

The relation between said audio signals is determined by measuring the auto-correlation coefficients and cross-correlation coefficients of the audio channels 2. This correlation information may be represented in a correlation matrix expressing the auto-correlation coefficients and cross-correlation coefficients. In this matrix, the coefficient <S(i)S(i)> expresses the auto-correlation of a channel i; the coefficient <S(i)S(j)> expresses the cross-correlation between channel i and channel j; i and j being some integral numbers denoting a specific one channel of said multi-channel system.

A set of transformation parameters 9 is calculated from this correlation matrix. The transformation parameters 9 are fed to a transmitter 10. The transformation parameters 9 relate to relevant parameters for synthesizing the noise sources. These transformation parameters may comprise an auto-correlation of the sources, corresponding to the energy of each uncorrelated noise signal, and a crosscorrelation, describing a specific relation between said noise sources. These parameters 9 are to be received by a decoder for performing the inverse transformation on a set of generated noise sources, further explained with reference to FIG. 2.

The transformation parameters 9 are then combined with the sinusoidal encoded non-noisy signals 7, and transmitted as an encoded signal 11 by transmitter 10. The transmission may be a wireless transmission, or a transmission via the Internet, in fact, any kind of transmission. The transmission may also be done via a physical data carrier, such as a magnetic disk or a CD-rom etc.

In FIG. 2, essentially, the reverse of the scheme of FIG. 1 is illustrated, in a decoder 12 for decoding a signal 11 into a set of audio signals 21. The signal 11 comprises a set of transformation parameters for forming a plurality of noise sources according to the method of the invention.

In a first splitting stage 13, the transformation parameters 9 and the encoded non-noisy signals 7 are extracted from the signal 11. The non-noisy signals 7 are fed to a sinusoidal decoder 14, outputting non-noisy parts 51 of audio channels 21.

The transformation parameters 9 are fed to a noise source generating stage 15 comprising a set of independent (random) noise generators 16. The transformation parameters 9 indicate a noise level of each noise generator 16 (including a possible zero level); additionally, other parameters like, for instance, an enveloping form may be specified for the noise sources. The noise generator 16 generates a composition of mutually uncorrelated noise sources that are formed in response to the set of transformation parameters 9, thereby synthesizing perceptually relevant correlation-preserved noise components 41 for audio signals 21. In a composition stage 17, the correlation-preserved noise components 41 and the non-noisy parts 51 are combined and audio channels 21 are outputted, which are a perceptually relevant reconstruction of the audio channels 2 of FIG. 1

It will be clear to those skilled in the art that the invention is not limited to the embodiments described with reference to the drawing but may comprise all kinds of variations. For instance, although in the embodiments described, non-noisy parts of the signal are encoded using a sinusoidal coding, other types of encoding may be applied, like waveform coding or Huffman coding. Also, the audio channels as a whole, including non-noisy parts, may be transformed according to the above-mentioned transformation parameters. Furthermore, other types of noise encoding maybe applied, using different parameters, etc. The method may be applied for a single relevant frequency band for an audio channel of a multi-channel audio system. The method may also be applied in a selected number of channels of a multi-channel audio system. These and other variations are deemed to fall within the scope of protection of the appended claims.

Reference Numbers:

1. encoder
2. composite arrows
3. filter stage
4. noisy parts
5. non-noisy parts
6. sinusoidal coding circuit
7. encoded data
8. noise encoding circuit
9. transformation parameters
10. transmitter
11. encoded signal
12. decoder
13. splitting stage
14. sinusoidal decoder
15. noise source generating stage
16. noise generators
17. composition stage

1. A method for encoding a set of audio signals wherein correlated components are present, the method comprising the step of:
determining, from the relation between said audio signals, a composition of sources, the composition being such that the sources in said composition are mutually uncorrelated or substantially uncorrelated, so that said composition of sources synthesizes said components in a relation-preserved way.

2. A method according to claim 1, further comprising the step of:
encoding the set of audio signals into an encoded signal, the encoded signal including a set of transformation parameters for generating said composition of sources, and
transmitting the encoded signal.

3. A method according to claim 1, wherein said sources are determined on a frame-by-frame basis.

4. A method according to claim 1, wherein non-noisy components present in said audio signals are encoded by sinusoidal coding.

5. A method according to claim 1, wherein said transformation parameters are determined by de-correlating a correlation matrix of said set of audio signals.

6. A method according to claim 1, wherein the set of audio signals is divided into a selected set of frequency bands, at least one of the frequency bands comprising noise-like signals.

7. A method for synthesizing a set of audio signals wherein correlated components are present, the method comprising the steps of:
receiving an encoded signal, the encoded signal including a set of transformation parameters for generating a composition of sources, the composition being such that the sources in said composition are mutually uncorrelated or substantially uncorrelated, so that said composition of sources synthesizes said components in a relation-preserved way;
generating, in response to said encoded signal, a set of synthesized sources; and
generating the set of audio signals by forming each audio signal as a plurality of said components.

8. An encoder for encoding a set of audio signals wherein correlated components are present, the device comprising:
means for determining, from the relation between said audio signals, a composition of sources, the composition being such that the sources in said composition are mutually uncorrelated or substantially uncorrelated, so that said composition of sources synthesizes said components in a relation-preserved way.

9. An encoder, for encoding audio channels, the encoder comprising:
means for detecting, in at least one frequency band of said audio channels, an auto-correlation and a cross-correlation between each one of a set of audio signals; and
processing means for determining, from the relation between said audio signals, a composition of sources, the composition being such that the sources in said composition are mutually uncorrelated or substantially uncorrelated, so that said composition of sources synthesizes said components in a relation-preserved way.

10. An encoder of claim 9, further comprising:
means for encoding said set of audio signals into an encoded signal, the encoded signal including a set of transformation parameters for generating said composition of sources, and
transmitting means for transmitting the encoded signal.

11. A decoder for synthesizing a set of audio signals, the decoder comprising:
receiving means for receiving an encoded signal, the encoded signal including a set of transformation parameters for generating a composition of sources, the composition being such that the sources in said composition are mutually uncorrelated or substantially uncorrelated, so that said composition of sources synthesizes said components in a relation-preserved way;
a set of generators for generating sources, in response to the encoded signal; and
synthesizing means for synthesizing said audio signals by forming, in response to the set of transformation parameters, for each audio signal a plurality of said components.

12. A data carrier comprising an encoded signal comprising a set of transformation parameters for forming a plurality of sources, a composition of the sources being such that the sources in said composition are mutually uncorrelated or substantially uncorrelated, so that said composition of sources synthesizes said components in a relation-preserved way.

13. An encoded signal comprising a set of transformation parameters for forming a plurality of sources, a composition of the sources being such that the sources in said composition are mutually uncorrelated or substantially uncorrelated, so that said composition of sources synthesizes said components in a relation-preserved way.
